(19) United States
(12) Patent Application Publication
(10) Pub. No.: US 2008/0160852 A1
(43) Pub. Date: Jul. 3, 2008

(54) Flame retardant, heat-insulated and moisture permeable coated fabric and its manufacturing method

(76) Inventor: Chou-Fu Yang, Taipei County (TW)

Correspondence Address: Dr. BANGER SHIA, 102 Lindencrest Ct., Sugar Land, TX, 77479-5201, US

(21) Appl. No.: 11/953,850

(22) Filed: Dec. 10, 2007

(30) Foreign Application Priority Data
Dec. 29, 2006 (TW) 095150001

(51) Int. Cl. B32B 5/24; B05D 3/02; B32B 5/28

(52) U.S. Cl. 442/223; 427/373; 442/226; 442/372; 442/374

(57) ABSTRACT

A flame retardant, heat-insulated and moisture permeable coated fabric and its manufacturing method comprises the steps of: mixing the expandable graphite with the chemical containing phosphorus or nitrogen; mixing the mixture of the expandable graphite and the chemical containing phosphorus or nitrogen in the foam material to form the to-be-coated material; one-side or two-sides coating the to-be-coated material on the surface of the textile cloth by using wet coating to form at least one flame retardant, heat-insulated and moisture permeable coating which can permeate the textile cloth on the surface of the textile cloth. Thereby, the flame retardant, heat-insulated and moisture permeable coating can absorb heat and expand to form the porous structure, which not only can absorb heat and smoke simultaneously, but also can wrap the textile cloth to avoid the phenomena of secondary combustion and melting drip.

### BACKGROUND OF THE INVENTION

1. Field of the Invention

The present invention relates to a flame retardant fabric, and more particularly to a flame retardant, heat-insulated and moisture permeable coated fabric which can absorb heat and smoke simultaneously, and can wrap a textile cloth to avoid the phenomena of secondary combustion and melting drip.

2. Description of the Prior Art

Nowadays, flame retardant fabrics are used more and more widely in industry and business, in addition to the effect of flame retardant, the flame retardant fabrics have the characteristics of improving the survival probability and reducing the chance of combustion. Therefore, the use of flame retardant fabrics is very important to various industries.

Currently, the flame retardant fabric is professionally called flame retardant textile fabric. There are two kinds of conventional flame retardant fabrics appeared in the market, one kind is the permanent flame retardant textile fabric, and the other kind is the finishing flame retardant textile fabric. In order to know the advantages and disadvantages of the conventional products, please read the following descriptions:

The permanent flame retardant textile fabric is formed by a textile technology which is to add flame retardant to man-made textile fiber at times and to form a permanent flame retardant effect. However, the above-mentioned conventional technology still has the following disadvantages:

Firstly, the technology of the permanent flame retardant textile fabric only can be applied to the man-made textile fabric, and the existing technology still cannot utilize the natural fiber to manufacture the permanent flame retardant textile fiber.

Secondly, since the man-made fiber produces a great amount of poisonous thick smoke during combustion, which will not only make escape difficult, but also the poisonous thick smoke will cause serious harm to human health.

Thirdly, the man-made fiber will be melted during combustion and will produce melting drips, as a result, the phenomenon of secondary combustion will occur in the melting position where the melting drops fell.

The finishing flame retardant textile fabric is formed by the process finished after textile fabric weaving and the technologies of dipping, coating and attaching which are to form a flame retardant having the flame retardant effect on the surface of the textile fabric. The flame retardant used in such a finishing flame retardant textile fabric is divided into organic flame retardant, such as bromine series, chlorine series, halogen or non-halogen phosphate, and inorganic flame retardant, such as aluminium hydroxide, antimony oxide, magnesium hydroxide and zinc borate. However, the above-mentioned conventional technologies still have the following disadvantages:

Firstly, the organic products having bromine and halogen will produce poisonous gases after being combusted, and the combustion gases produced by the inorganic flame retardant will have a danger of causing cancer. Currently, the European Parliament has announced the prohibition of aluminium trioxide, pentabromodiphenyl ether, octabromobiphenyl ether, pentabromophenyl ether and halogen flame retardant from 2000. Obviously, the above-mentioned finishing flame retardant textile fabric must be improved immediately, or else, it will lose the market.

Secondly, the finishing flame retardant textile fabric will be melted during combustion and will produce melting drips, as a result, the phenomenon of secondary combustion will occur in the melting position where the melting drops fell.

To solve the above-mentioned problems, a new flame retardant, heat-insulated and moisture permeable coated fabric which can avoid the poisonous smoke and the phenomenon of secondary combustion is developed.

The present invention has arisen to mitigate and/or obviate the afore-described disadvantages.

### SUMMARY OF THE INVENTION

The primary objective of the present invention is to provide a flame retardant, heat-insulated and moisture permeable coated fabric which not only can absorb heat and smoke, but also can avoid the phenomena of secondary combustion and melting drip.

To achieve the objective of the present invention, the present invention comprises the steps of: mixing an expandable graphite with a chemical containing phosphorus or nitrogen; mixing the mixture of the expandable graphite and the chemical containing phosphorus or nitrogen in a foam material to form a to-be-coated material, so as to form at least one flame retardant, heat-insulated and moisture permeable coating which can permeate the textile cloth on the surface of the textile cloth.

Thereby, the flame retardant, heat-insulated and moisture permeable coating can absorb heat and expand to form a porous structure, which not only can absorb heat and smoke simultaneously, but also can wrap the textile cloth to avoid the phenomena of secondary combustion and melting drip.

It is to be noted that the flame retardant, heat-insulated and moisture permeable coated fabric of the present invention can be superposed and can form the multi-layer porous structure by expanding layer by layer after absorbing heat, thus ensuring better effects of separating high heat and poisonous smoke.

The second objective of the present invention is to provide a method for manufacturing a flame retardant, heat-insulated and moisture permeable coated fabric.

Referring to FIGS. 1, a method for manufacturing a flame retardant, heat-insulated and moisture permeable coated fabric in accordance with the present invention is shown, which comprises the following steps:

mixing an expandable graphite with a chemical containing phosphorus or nitrogen;

mixing the mixture of the expandable graphite and the chemical containing phosphorus or nitrogen in a foam material to form a to-be-coated material;

coating the to-be-coated material on a surface of a textile cloth by using wet coating;

drying.

By the above-mentioned steps, at least one flame retardant, heat-insulated and moisture permeable coating which can permeate the textile cloth can be formed on the surface of the textile cloth. In addition, the flame retardant, heat-insulated and moisture permeable coating can absorb heat and expand to form a porous structure, which not only can absorb heat and smoke simultaneously, but also can wrap the textile cloth to avoid the phenomena of secondary combustion and melting drip.

It is to be noted that the flame retardant, heat-insulated and moisture permeable coating of the present invention enables the textile cloth to ventilate and to permeate moisture. Further, if the products are required to have the characteristics of moisture resistance and hydrolysis resistance, the present invention can carry out a water resistant treatment after the above-mentioned steps, so as to improve the hydrolysis resistant ability of the present invention.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an illustrative view showing steps of a method for manufacturing a flame retardant, heat-insulated and moisture permeable coated fabric in accordance with the present invention;

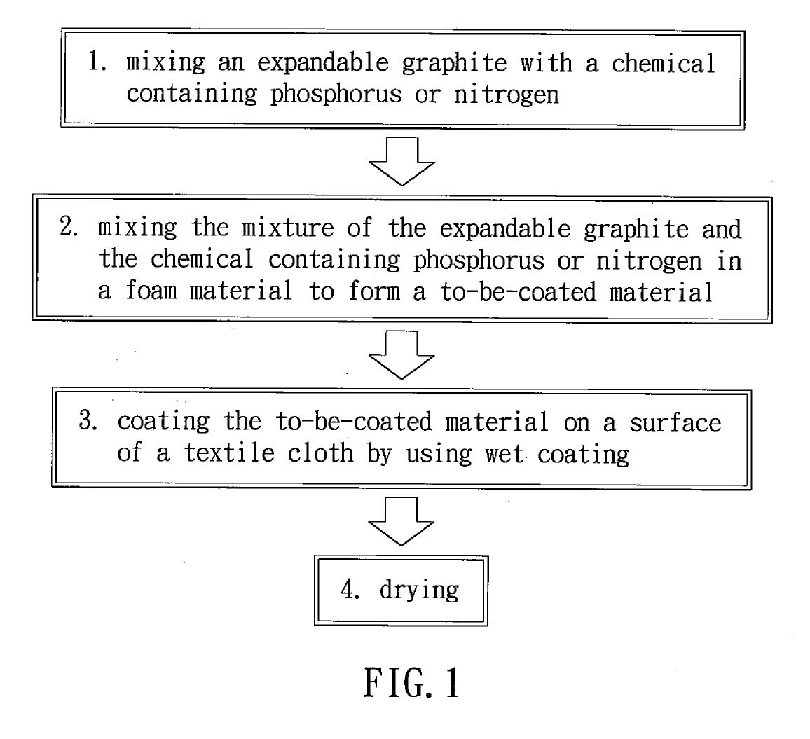

FIG. 2 is an illustrative view showing the method for manufacturing a flame retardant, heat-insulated and moisture permeable coated fabric in accordance with a first embodiment of the present invention;

FIG. 3 is an illustrative view showing the flame retardant, heat-insulated and moisture permeable coated fabric after being heated in accordance with the first embodiment of the present invention; and

FIG. 4 is an illustrative view of the method for manufacturing a flame retardant, heat-insulated and moisture permeable coated fabric in accordance with a second embodiment of the present invention.

### DETAILED DESCRIPTION OF THE PREFERRED EMBODIMENTS

The detailed steps of the method for manufacturing an flame retardant, heat-insulated and moisture permeable coated fabric of the present invention are described as follows:

Mixing an expandable graphite with a chemical containing phosphorus or nitrogen: firstly proportionally mixing the expandable graphite with the chemical containing phosphorus or nitrogen.

Mixing the mixture of the expandable graphite and the chemical containing phosphorus or nitrogen in a foam material to form a to-be-coated material: adding the above-mentioned mixture of the expandable graphite and the chemical containing phosphorus or nitrogen to the foam material to form the to-be-coated wet material having a viscosity of 2000-3500 cps.

Coating the to-be-coated material on the surface of the textile cloth by using wet coating: coating the to-be-coated material having a viscosity of 2000-3500 cps on the surface of the textile cloth to form the flame retardant, heat-insulated and moisture permeable coating by using wet coating and foaming process.

Drying: drying the flame retardant, heat-insulated and moisture permeable coating and textile cloth at the temperature of 140-150° C., and setting the weight of each flame retardant, heat-insulated and moisture permeable coating after being dried to 35%-70% of the whole weight (the weight of the flame retardant, heat-insulated and moisture permeable coated fabric).

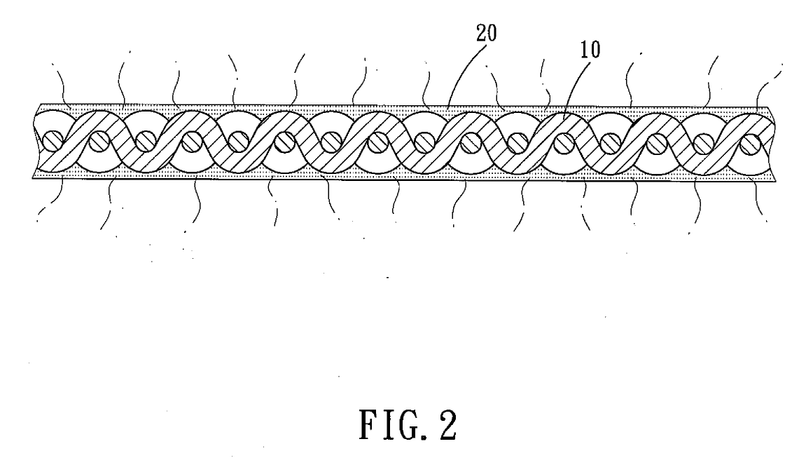

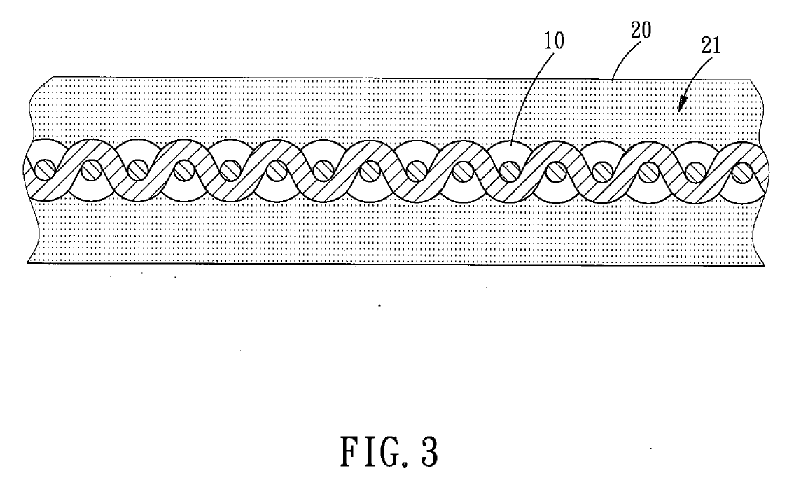

Referring to FIGS. 2 and 3, the flame retardant, heat-insulated and moisture permeable coated fabric after being heated in accordance with a first embodiment of the present invention is shown. Both surfaces of the textile cloth 10 of the present invention are coated with the flame retardant, heat-insulated and moisture permeable coating 20 having the expandable graphite, the chemical containing phosphorus or nitrogen and the foam material. In addition, the flame retardant, heat-insulated and moisture permeable coatings 20 are coated by using wet coating and enable the textile cloth 10 to ventilate and to permeate moisture.

The textile cloth 10 is made of man-made fiber or natural fiber.

The foam material of the flame retardant, heat-insulated and moisture permeable coatings 20 is polyurethane, polyvinyl acetate, polyethylene, polypropylene or acrylic rubber.

When being heated, the expandable graphite, the chemical containing phosphorus or nitrogen and the foam material of the above-mentioned flame retardant, heat-insulated and moisture permeable coatings 20 will expand to form the porous structure 21 that can absorb heat and poisonous smoke simultaneously. With the continuous expansion and separation of the two-faced, two-tier and porous structure 21, the present invention can effectively increase the survival probability, prevent the fire from expanding and reduce the consequential loss. Moreover, the expanded porous structure 21 of the flame retardant, heat-insulated and moisture permeable coatings 20 will wrap and separate the textile cloth 10, which not only has the heat insulation effect, but also can prevent the textile cloth 10 from melting, so as to avoid the phenomenon of melting drip, thus avoiding secondary combustion.

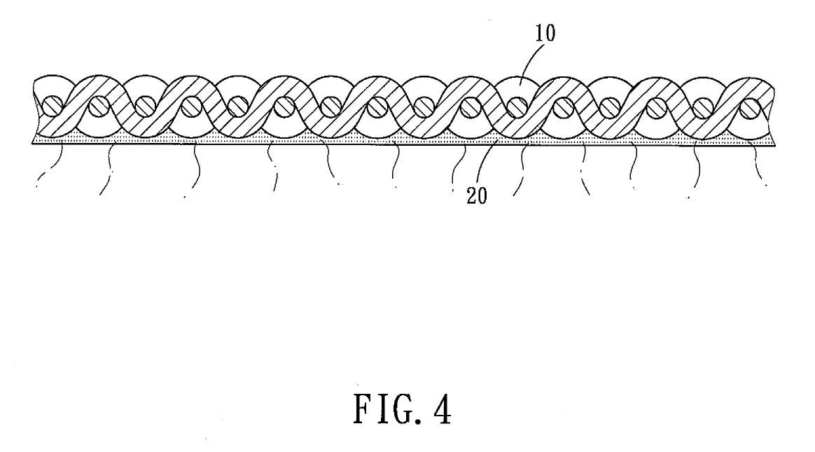

Referring to FIG. 4, the flame retardant, heat-insulated and moisture permeable coated fabric in accordance with a second embodiment of the present invention is shown, wherein one side of the textile cloth 10 is coated with the flame retardant, heat-insulated and moisture permeable coating 20. The one-side flame retardant, heat-insulated and moisture permeable coating 20 will also produce the same effects, so it is still within the scope of the present invention.

The detailed example showing how to prepare the material of the 20 and its manufacturing method are described in the following table:

| Step | Number | Material | Weight |
|---|---|---|---|
| mixing an expandable | 1 | neutral expandable graphite | 3 (KG) |
| graphite with a | 2 | ammonium polyphosphate | 2 (KG) |
| chemical containing | 3 | 1000 red phosphorus | 1 (KG) |
| phosphorus or | | | |
| nitrogen. | | | |
| mixing the mixture of | 1 | polyurethane adhesive | 100 (KG) |
| the expandable | | | |
| graphite and the | 2 | floury flame retardant | 30-50 (KG) |
| chemical containing | | dissolving the flame retardant by evenly | |
| phosphorus or nitrogen | | mixing it with dimethylformamide | |
| in a foam material to | | (DMF), and then, adding half of the | |
| form a to-be-coated | | dissolved flame retardant to the | |
| material. | | polyurethane adhesive at a time, and | |
| | | evenly mixing them up, thereafter, | |
| | | adding the remanent half of the | |
| | | dissolved flame retardant. | |
| | 3 | foamer | 2-3 (KG) |
| | 4 | accelerant | 1-1.5 (KG) |
| | 5 | smooth agent | 1 (KG) |
| | 6 | a suitable amount of | 3 (KG) |
| | | dimethylformamide (DMF) having a | |
| | | viscosity of 2000-3500 cps | |
| | 7 | color paste (white or black)-matching | 1-3 (KG) |
| | | according to the color depth | |
| | 8 | cross linking agent-finally added | 3-5 (KG) |

It is apparent from the materials, steps and structures disclosed in the above-mentioned table that the feature, implementing data and characteristics of the present invention are clearly described.

To summarize, the present invention comprises the steps of: mixing the expandable graphite with the chemical containing phosphorus or nitrogen; mixing the mixture of the expandable graphite and the chemical containing phosphorus or nitrogen in the foam material to form the to-be-coated material; one-side or two-sides coating the to-be-coated material on the surface of the textile cloth by using wet coating to form at least one flame retardant, heat-insulated and moisture permeable coating which can permeate the textile cloth on the surface of the textile cloth. Thereby, the flame retardant, heat-insulated and moisture permeable coating can absorb heat and expand to form the porous structure, which not only can absorb heat and smoke simultaneously, but also can wrap the textile cloth to avoid the phenomena of secondary combustion and melting drip.

While we have shown and described various embodiments in accordance with the present invention, it should be clear to those skilled in the art that further embodiments may be made without departing from the scope of the present invention.

What is claimed is:

1. A flame retardant, heat-insulated and moisture permeable coated fabric, comprising: a textile cloth and at least one flame retardant, heat-insulated and moisture permeable coating, characterized in that:
the flame retardant, heat-insulated and moisture permeable coating includes an expandable graphite, a chemical containing phosphorus or nitrogen and a foam material and is coated on a surface of the textile cloth by using wet coating.

2. The flame retardant, heat-insulated and moisture permeable coated fabric as claimed in claim 1, wherein the textile cloth is made of man-made fiber or natural fiber.

3. The flame retardant, heat-insulated and moisture permeable coated fabric as claimed in claim 1, wherein both surfaces of the textile cloth are coated with the flame retardant, heat-insulated and moisture permeable coating.

4. The flame retardant, heat-insulated and moisture permeable coated fabric as claimed in claim 1, wherein the foam material of the flame retardant, heat-insulated and moisture permeable coatings is selected from a group consisting of polyurethane, polyvinyl acetate, polyethylene, polypropylene and acrylic rubber.

5. A method for manufacturing a flame retardant, heat-insulated and moisture permeable coated fabric, comprising the following steps:
mixing an expandable graphite with a chemical containing phosphorus or nitrogen;
mixing a mixture of the expandable graphite and the chemical containing phosphorus or nitrogen in a foam material to form a to-be-coated material;
coating the to-be-coated material on a surface of a textile cloth by using wet coating;
drying;
by the above-mentioned steps, at least one flame retardant, heat-insulated and moisture permeable coating being formed on the surface of the textile cloth and expanding to form a porous structure after absorbing heat.

6. The method for manufacturing a flame retardant, heat-insulated and moisture permeable coated fabric as claimed in claim 5, wherein a to-be-coated wet material having a viscosity of 2000-3500 cps is formed in the step of mixing the mixture of the expandable graphite and the chemical containing phosphorus or nitrogen in the foam material.

7. The method for manufacturing a flame retardant, heat-insulated and moisture permeable coated fabric as claimed in claim 5, wherein the flame retardant, heat-insulated and moisture permeable coating and the textile cloth are dried at a temperature of 140-150° C., and a weight of each flame retardant, heat-insulated and moisture permeable coating after being dried is set to 35%-70% of a whole weight (a weight of the flame retardant, heat-insulated and moisture permeable coated fabric) in the step of drying.

8. The method for manufacturing a flame retardant, heat-insulated and moisture permeable coated fabric as claimed in claim 5, wherein neutral expandable graphite, ammonium polyphosphate and red phosphorus are used in the step of mixing the expandable graphite with the chemical containing phosphorus or nitrogen;
a color paste matched by polyurethane adhesive, floury flame retardant, foamer, accelerant, smooth agent and dimethylformamide according to a color depth is mixed with a finally added cross linking agent in the step of mixing the mixture of the expandable graphite and the chemical containing phosphorus or nitrogen in the foam material.

9. The method for manufacturing a flame retardant, heat-insulated and moisture permeable coated fabric as claimed in claim 8, wherein a weight of the neutral expandable graphite is 3 KG, a weight of the ammonium polyphosphate is 2 KG, a weight of the red phosphorus is 1 KG, a weight of the polyurethane adhesive is 100 KG, a weight of the floury flame retardant is 30-50 KG, a weight of the roamer is 2-3 KG, a weight of the accelerant is 1-1.5 KG, a weight of the smooth agent is 1 KG, a suitable amount of dimethylformamide is added, a weight of the color paste is 1-3 KG and a weight of the cross linking agent is 3-5 KG.

10. The method for manufacturing a flame retardant, heat-insulated and moisture permeable coated fabric as claimed in claim 5 further comprising a water resistant treatment after the step of drying for enabling the flame retardant, heat-insulated and moisture permeable coated fabric to have better moisture resistant and hydrolysis resistant abilities.
